(19) United States
(12) Patent Application Publication
(10) Pub. No.: US 2018/0267774 A1
(43) Pub. Date: Sep. 20, 2018

(54) CONFERENCE ASSISTANT DEVICE WITH CONFIGURABLE USER INTERFACES BASED ON OPERATIONAL STATE

(71) Applicant: Cisco Technology, Inc., San Jose, CA (US)

(72) Inventors: Otto Williams, Berkeley, CA (US); David M. Sanguinet, San Jose, CA (US)

(21) Appl. No.: 15/615,339

(22) Filed: Jun. 6, 2017

Related U.S. Application Data
(60) Provisional application No. 62/472,086, filed on Mar. 16, 2017.

(51) Int. Cl. G06F 3/16; G06F 3/0481; G06F 3/041; G06F 3/02; H04W 4/00; H04L 12/18

(52) U.S. Cl. CPC G06F 3/167; G06F 3/0481; H04L 12/1822; G06F 3/02; H04W 4/008; G06F 3/041

(57) ABSTRACT

The present technology is a hybridized user interface model where different interaction methods work together in concert to make public conference calling devices much easier to use. The interaction on the device consists of voice UI together with physical capacitive touch interaction (variable function based on context), as well as remote control from any personal computing device, i.e. mobile phone, tablet, laptop computer, etc.

### CROSS REFERENCE TO RELATED APPLICATIONS

This application claims priority to U.S. provisional application No. 62/472,086, filed on Mar. 16, 2017, which is expressly incorporated by reference herein in its entirety.

### TECHNICAL FIELD

The present disclosure pertains to a conference assistant device, and more specifically to use of a conference assistant device having at least two user interface controls that are configurable based on an operational state of the conference assistant device.

### BACKGROUND

Multiparty conferencing allows participants from multiple locations to collaborate. For example, participants from multiple geographic locations can join a conference meeting and communicate with each other to discuss issues, share ideas, etc. These collaborative sessions often include two-way audio transmissions. However, in some cases, the meetings may also include one or two-way video transmissions as well as tools for the sharing of content presented by one participant to other participants. Thus, conference meetings can simulate in-person interactions between people.

Conferencing sessions are typically started by having users in each geographic location turn on some conferencing equipment (e.g., a telephone, computer, or video conferencing equipment), inputting a conference number into the equipment, and instructing the conferencing equipment to dial that number.

Recently some conference rooms now have conference assistant devices that assist in joining or initiating a meeting. Typical conferences with assistant devices are public devices which have complex interfaces (either touch screen interface or mechanical keypad interface or limited voice interfaces) that require a learning curve for untrained users. If a user is unfamiliar with the interface of the public device, there will likely be a delay in meeting start or an aborted connection attempt. This delay or aborted connection attempt is a common problem in conferencing, since different locations often have different equipment in their conferencing rooms. Voice UI is a means to greatly simplify the control of communication devices, but this interaction becomes awkward when the device in an active call state (2-way communication). Accordingly, there is need for a conference assistant device that is easy to use and intuitive, such that a user unfamiliar with the interface will not have to train or endure a learning curve in order to use it.

### BRIEF DESCRIPTION OF THE DRAWINGS

The above-recited and other advantages and features of the disclosure will become apparent by reference to specific embodiments thereof which are illustrated in the appended drawings. Understanding that these drawings depict only example embodiments of the disclosure and are not therefore to be considered to be limiting of its scope, the principles herein are described and explained with additional specificity and detail through the use of the accompanying drawings in which:

FIG. 1 is a conceptual block diagram illustrating an example environment for providing conferencing capabilities, in accordance with various embodiments of the subject technology;

FIG. 2 is an illustration of a conference assistant device, collaboration service, and portable computing device use together in a conference interaction, in accordance with various embodiments;

FIGS. 3A, 3B, 3C, 3D, 3E, and 3F illustrates example operational states of a conference assistant device;

FIG. 4 is a table illustrating example user interface control configurations for operational states of a conference assistant device;

FIG. 5 is a flowchart illustrating an exemplary method for determining an operational state of the conference assistant device; and

FIG. 6 shows an example system embodiment.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### Overview:

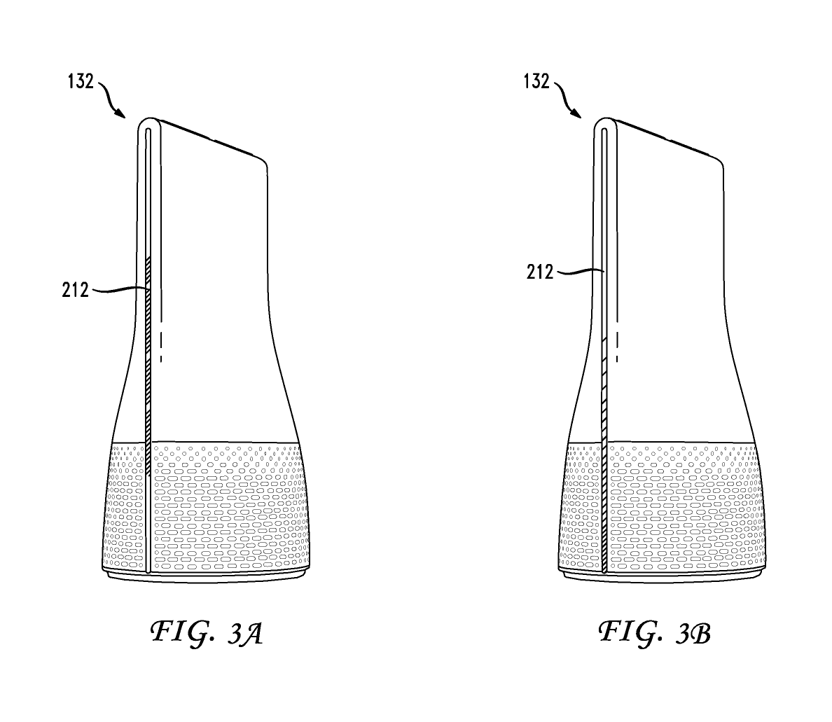

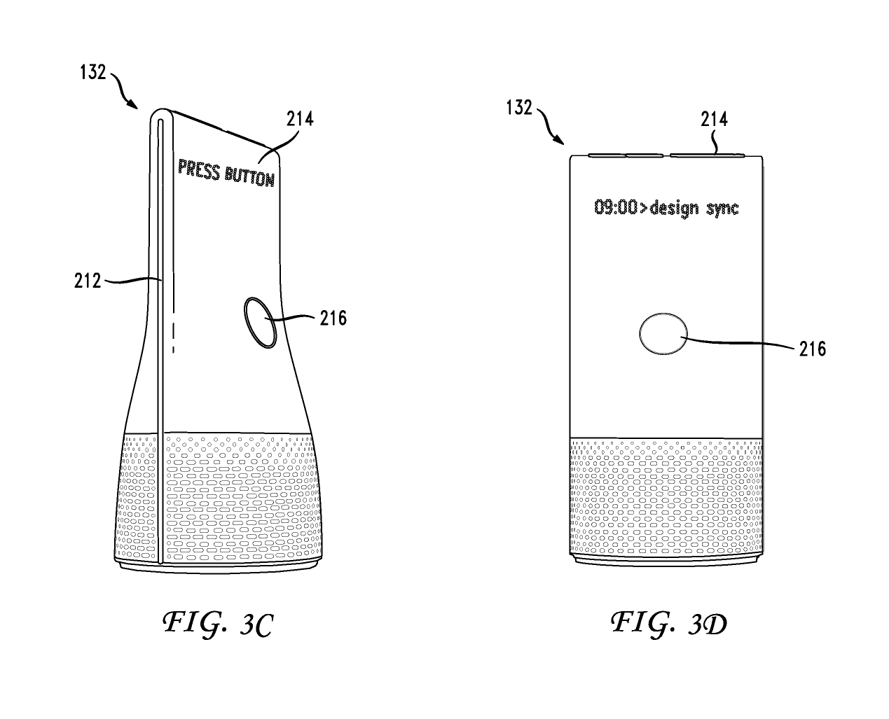

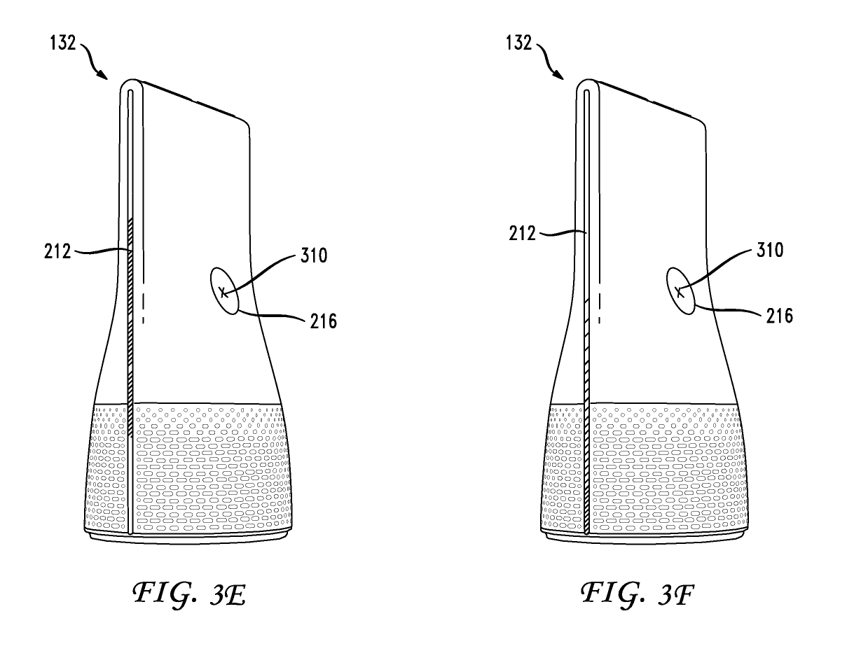

The present technology is a hybridized user interface which enables a hybrid interaction model where different user interface interaction devices and informational user interfaces work together in concert to make conference calling devices easier to use. The user interface interaction embodiments on the device include a voice UI together with a physical capacitive touch surface. The device can furthermore be remotely controlled from any personal computing device, i.e. mobile phone, tablet, laptop computer, etc. Additionally the device includes informational user interfaces including a LED panel, an LED dot matrix text display, and LED/LCD displays to indicate function of software user interface interaction devices such as soft buttons on the capacitive touch surface. The LEDs and LCDs can be located underneath a semi-translucent plastic surface and light up, animate, pulse, and change color based on user proximity, user identification, voice interaction, and varied device states. A hidden LED dot matrix text display and/or LCDs on the front of the device can appear and animate to display contextually relevant textual instructions to augment the audible instructions emitted by the device. Hidden LED/LCDs surround or appear on a singular capacitive touch surface area which changes function/action based on the device state. The LEDs surrounding or appearing on the capacitive touch area change motion and color and displayed symbols based on the device state in order to prompt user behavior. The hybrid interaction model allows users to interact with the device more naturally by configuring the user interface controls during different device operational modes—e.g. pre-call, in-call, post-call, etc. The hybrid interaction model also allows the device itself to inform the user how to operate it. Moreover, depending on the device state, the device can configure the user interfaces described above and herein. Examples of user interface control configurations are shown in FIG. 3.

### DETAILED DESCRIPTION

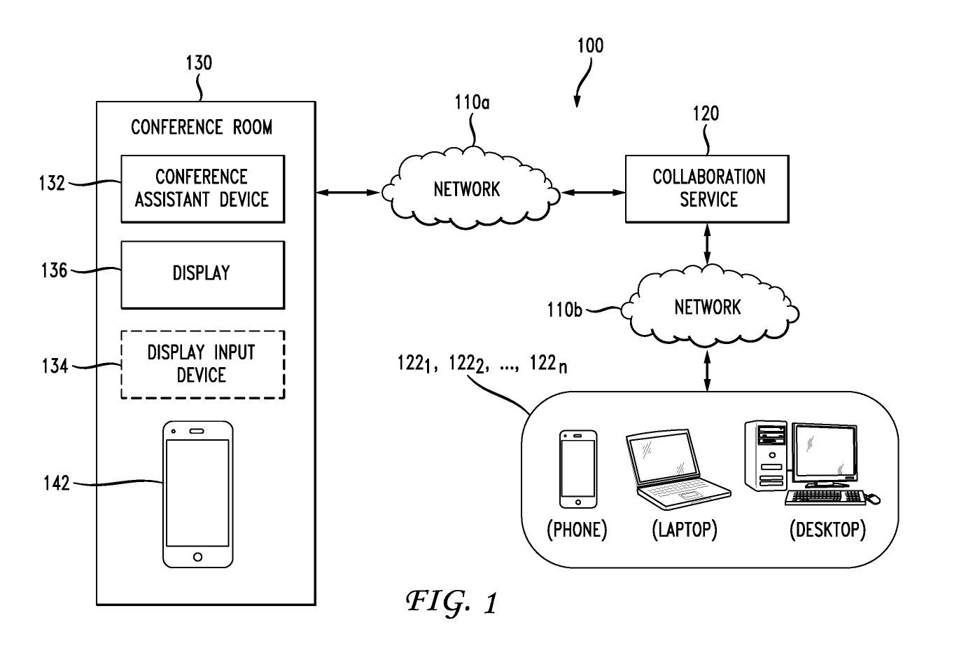

FIG. 1 is a conceptual block diagram illustrating an example environment for providing conferencing capabilities, in accordance with various embodiments of the subject technology. Although FIG. 1 illustrates a client-server network environment 100, other embodiments of the subject technology may include other configurations including, for example, peer-to-peer environments.

FIG. 1 illustrates a collaboration service 120 server that is in communication with communication devices (122₁, 122₂, . . . , 122ₙ, 142) from one or more geographic locations, such as through one or more networks 110a, 100b. The communication devices (122₁, 122₂, . . . , 122ₙ, 142) can take any from factor, such as a portable device, laptop, desktop, tablet, etc. In FIG. 1, a conference room 130 is in one such geographic location containing a portable device 142. However, as will be appreciated by those skilled in the art, in some embodiments the communication devices (122₁, 122₂, . . . , 122ₙ, 142) do not necessarily need to be in a room.

Conference room 130 includes a conference assistant device 132, a display input device 134, and a display 136. Display 136 may be a monitor, a television, a projector, a tablet screen, or other visual device that may be used during the conferencing session. Display input device 134 is configured to interface with display 136 and provide the conferencing session input for display 136. Display input device 134 may be integrated into display 136 or separate from display 136 and communicate with display 136 via a Universal Serial Bus (USB) interface, a High-Definition Multimedia Interface (HDMI) interface, a computer display standard interface (e.g., Video Graphics Array (VGA), Extended Graphics Array (XGA), etc.), a wireless interface (e.g., Wi-Fi, infrared, Bluetooth, etc.), or other input or communication medium. In some embodiments, display input device 134 may be integrated into conference assistant device 132.

In FIG. 1, the conference assistant device 132 can determine that the portable device 142 and/or participant(s) have entered the conference room 130 or are otherwise ready to join a conference meeting. In some embodiments, once the portable device 142 has entered the conference room 130, the portable device 142 communicates with the collaboration service 120 through network 110a to inform the collaboration service 120 that the portable device 142 has entered the room.

The portable device 142 can inform the collaboration service 120 that it has entered the conference room 130 and/or is ready to initiate/join a conference meeting in a number of ways. For example, once the portable device 142 has detected that a conference assistant device 132 is located nearby, the portable device 142 can automatically transmit a notification to the collaboration service 120. Other examples contemplate an application (e.g., a collaboration service application) on the portable device 142 that informs the collaboration service 120 that it is located nearby or in the conference room 130. An application running in the portable device's 142 background, for example, can transmit a notification to the collaboration service 120 to that effect, or the application can receive and/or request user input from a participant that they have entered the room and are interested in joining a meeting. However the collaboration service 120 is notified, the collaboration service 120 transmits that information to the conference assistant device 132. Accordingly, the conference assistant device 132 detects that the portable device 120 is in the conference room 130 and can initiate a conference meeting.

Additionally and/or alternatively, the conference assistant device 132 itself can be configured to detect when a user comes within range of conference room 130, conference assistant device 132, or some other location marker. Some embodiments contemplate detecting a user based on an ultrasound frequency emitted from the conference assistant device 132.

Conference assistant device 132 is configured to coordinate with the other devices in the conference room 130 and collaboration service 120 to start and maintain a conferencing session. For example, conference assistant device 132 may interact with portable device 142 associated with one or more users to facilitate a conferencing session, either directly or through the collaboration service 120 via networks 110a and/or 110b. Portable device 142 may be, for example, a user's smart phone, tablet, laptop, or other computing device.

Portable device 142 may have an operating system and run one or more collaboration service applications that facilitate conferencing or collaboration, and interaction with conference assistant device 132. For example, a personal computing device application, such as a collaboration application, running on portable device 142 may be configured to interface with the collaboration service 120 or the conference assistant device 132 in facilitating a conferencing session for a user.

While not illustrated, conference room 130 can include at least one audio device which may include one or more speakers, microphones, or other audio equipment that may be used during the conferencing session. Conference assistant device 132 is configured to interface with at least one audio device and provide the conferencing session input for the at least one audio device. The at least one audio device may be integrated into conference assistant device 132 or separate from the conference assistant device 132.

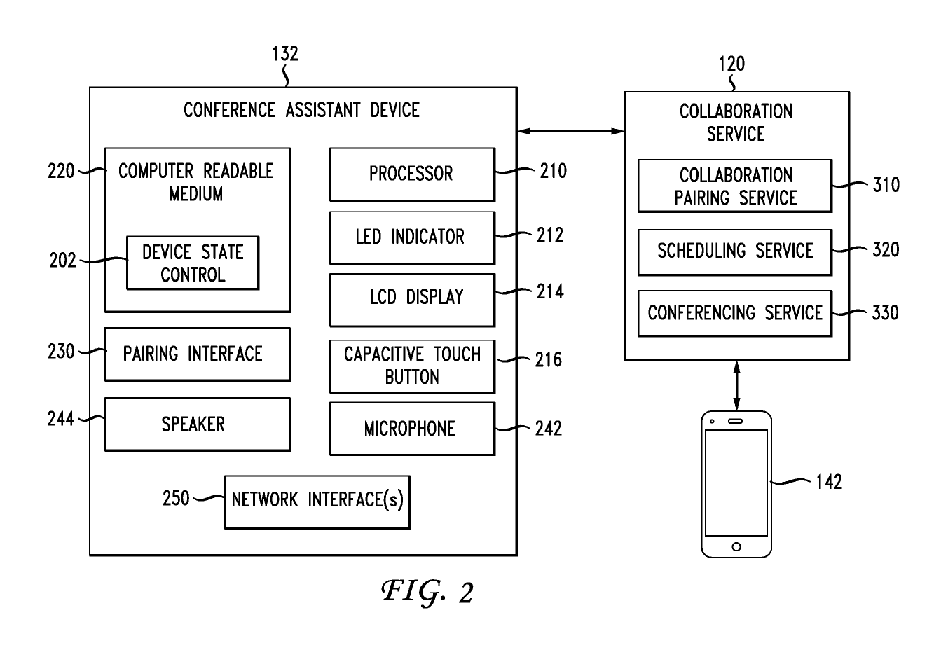

FIG. 2 is an illustration showing more detail of a conference assistant device 132, collaboration service 120, and portable device 142 according to some embodiments.

Conference assistant device 132 may include processor 210 and computer-readable medium 220 storing instructions that, when executed by the conference assistant device 132, cause the conference assistant device 132 to perform various operations for facilitating a conferencing session. In some embodiments, the conference assistant device 132 may communicate with the collaboration service 120 to receive conference state information, which informs which operation state the conference assistant device 132 needs to configure itself to be in. For example, computer readable medium 220 can store instructions making up a device state control 202. Device state control 202, when executed by processor 210, is effective to configure user interface controls of conference assistant device 132 based on the operational state of the conference assistant device 132. Such user interface controls will vary based on the context with which the conference assistant device 132 is operating. For example, one operation state (e.g., a boot/connecting state) will cause the conference assistant device 132 to configure a different user interface control than another operation state (e.g., an in-call state with the microphone muted). Examples of such configurations are illustrated in FIGS. 3A-3F.

Conference assistant device 132 may further include a pairing interface 230, and a network interface 250. Network interface 250 may be configured to facilitate conferencing sessions by communicating with collaboration service 120, display input device 134, and/or portable device 142.

Pairing interface 230 may be configured to detect when a portable device 142 is within range of the conference room, conference assistant device 132, or some other geographic location marker. For example, pairing interface 230 may determine when the portable device 142 is within a threshold distance of conference assistant device 132 or when portable device 142 is within range of a sensor of conference assistant device 132. Pairing interface 230 may include one or more sensors including an ultrasonic sensor, a time-of-flight sensor, a microphone, a Bluetooth sensor, a near-field communication (NFC) sensor, or other range determining sensors.

An ultrasonic sensor may be configured to generate sound waves. The sound waves may be high frequency (e.g., frequencies in the ultrasonic range that are beyond the range of human hearing). However, in other embodiments, other frequency ranges may be used. In some embodiments, the sound waves may be encoded with information such as a current time and a location identifier. The location identifier may be, for example, conference assistant device 132 identifier, a geographic location name, coordinates, etc. The ultrasonic sound waves encoded with information may be considered an ultrasonic token.

Portable device 142 may detect the ultrasonic token and inform collaboration pairing service 310 that portable device 142 detected the ultrasonic token from the conference assistant device 132. The collaboration pairing service 310 may check the ultrasonic token to make sure the sound waves were received at the appropriate time and location. If portable device 142 received the ultrasonic token at the appropriate time and location, the collaboration pairing service 310 may inform conference assistant device 132 that the portable device is within range and pair conference assistant device 132 with portable device 142.

In some embodiments, conference assistant device 132 and portable device 142 may pair together directly, without the assistance of collaboration pairing service 310. Furthermore, in some embodiments, the roles are reversed where portable device 142 emits high frequency sound waves and the ultrasonic sensor of conference assistant device 132 detects the high frequency sound waves from portable device 142. In some embodiments, an ultrasonic sensor may be configured to generate high frequency sound waves, detect an echo which is received back after reflecting off a target, and calculate the time interval between sending the signal and receiving the echo to determine the distance to the target. A time-of-flight sensor may be configured to illuminate a scene (e.g., a conference room or other geographic location) with a modulated light source and observe the reflected light. The phase shift between the illumination and the reflection is measured and translated to distance.

Collaboration service 120 may include collaboration pairing service 310 (addressed above), scheduling service 320, and conferencing service 330.

Scheduling service 320 is configured to identify an appropriate meeting to start based on the paired devices. As will be discussed in further detail below, scheduling service 320 may identify a user associated with a portable device 142 paired with a conference assistant device 132 at a particular geographic location. Scheduling service 320 may access an electronic calendar for conference assistant device 132 at the geographic location, an electronic calendar for the user of portable device 142, or both to determine whether there is a conference meeting or session scheduled for the current time.

If there is a meeting or session scheduled, scheduling service 320 may ask the user if the user wants to start the meeting or session. For example, the scheduling service 320 may instruct the conference assistant device 132 to prompt the user to start the meeting or instruct a collaboration application on the portable device 142 to prompt the user to start the meeting.

An electronic calendar may include a schedule or series of entries for the user, a conference assistant device 132, a conference room 130, or any other resource associated with a conference meeting. Each entry may signify a meeting or collaboration session and include a date and time, a list of one or more participants, a list of one or more locations, or a list of one or more conference resources. The electronic calendar may be stored by the collaboration service 120 or a third party service and accessed by scheduling service 320.

In some embodiments, the conference assistant device 132 will not start a meeting or instruct a collaboration application on the portable device 142 to prompt the user unless a meeting or session has been scheduled beforehand, and the user associated with the portable device 142 has been authorized as a participant. In some embodiments, the collaboration application on the portable device 142 transmits the user's account credentials to the collaboration service 120. If the user's account credentials match a participant authorized in a scheduled meeting or session, the collaboration service 120 will pair the conference assistant device 132 with the portable device 142. Additionally and/or alternatively, some embodiments contemplate the conference assistant device 132 sending a command to the collaboration service 120 to pair the conference assistant device 132 with the portable device 142 once the conference assistant device 132 determines that a user is present. The commands from the conference assistant device 132 and collaboration application can be redundant.

Conferencing service 330 is configured to start and manage a conferencing session between two or more geographic locations. For example, the conference assistant device 132 may prompt the user to start the meeting and receive a confirmation from the user to start the meeting. Conference assistant device 132 may transmit the confirmation to collaboration service 120 and then the conferencing service 330 may initiate the conferencing session. In some embodiments, conferencing service 330 may initiate the conferencing session after the scheduling service 320 identifies an appropriate meeting to start without receiving a confirmation from the user or prompting the user to start the meeting.

In some embodiments, conference assistant device 132 may be configured for voice activated control. For example, conference assistant device 132 may receive and respond to instructions from a user. Instructions may be received by microphone 242, other sensor, or interface. For example, the user may enter a room and say “Please start my meeting.” The conference assistant device 132 may receive the instructions via microphone 242 and transmit the instructions to the collaboration service 120. The collaboration service 120 may convert the speech to text using speech-to-text functionality or third-party service. The collaboration service 120 may use natural language processing to determine the user's intent to start a meeting, identify an appropriate calendar entry for the user or conference room, and start the meeting associated with the calendar entry. In some cases, the collaboration service 120 may further use text-to-speech functionality or service to provide responses back to the user via the conference assistant device 132.

In some embodiments, the conference assistant device 132 includes multiple user interface controls that may be configured based on an operational state of the conference assistant device 132. The configuration of the multiple user interface controls can be adapted based on each operation state of the conference assistant device 132, including the voice activated control and at least one other user interface control. For example, the operational state determines the visual appearance and/or functionality of at least two features of the user interface controls. Examples of the multiple user interface controls include a speaker 244 that is configured to provide voice prompts and other information to a user; a microphone 242 that is configured to receive spoken instructions from a user which can be converted into commands based on the operational state of the conference assistant device 132; a capacitive touch button 216 that can be configured in some operational states to receive a touch given by user that can be interpreted as a command depending on the operational state conference assistant device 132; an LCD display 214 that can be configured to present informational text or symbols to the user in some operational states of the conference assistant device 132; and an LED indicator 212 that can be configured to display colored lighting or lighting patterns in some operational states. In embodiments, the conference assistant device 132 includes an LED indicator 212 on each side. The user interface controls, when invisible, are not activated.

In some embodiments, LCD display 214 can, in the alternative, be an LED dot matrix text display. The LED dot matrix display can be comprised of individual LED point lights in a grid or matrix that, when lit together, form alpha numeric characters.

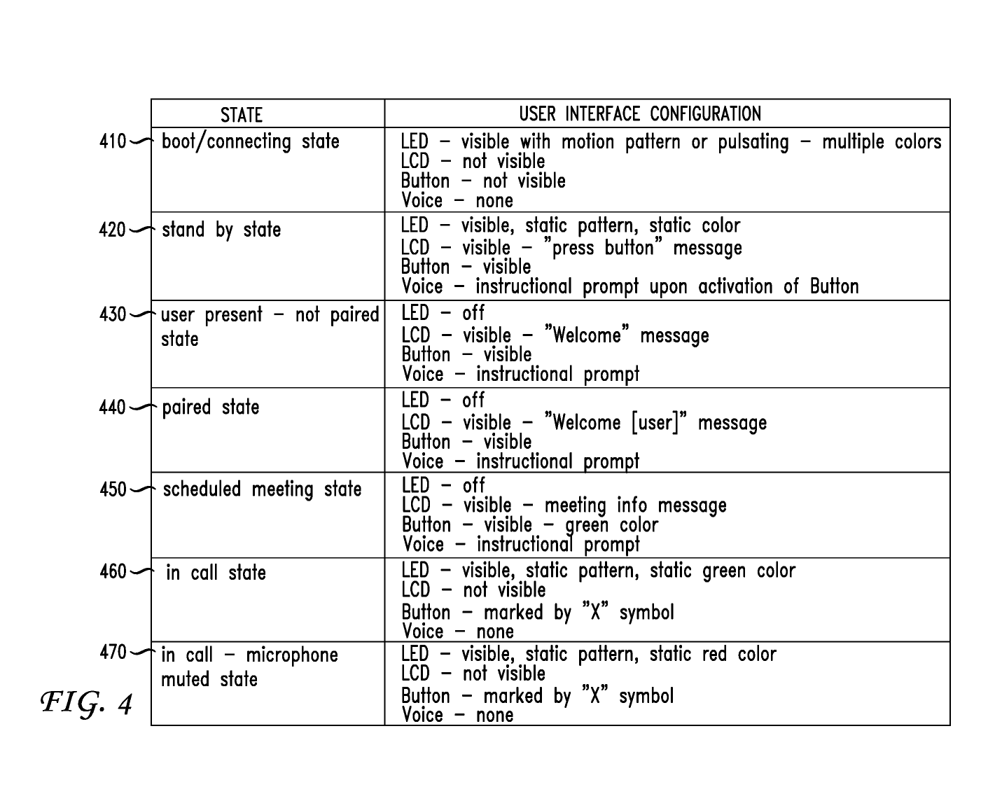

FIGS. 3A-3F illustrate example appearances and functions of the conference assistant device 132, and FIG. 4 is a table showing example embodiments of user interface control configurations associated with each operational state. The user interface controls can be indicators of the operational state of the conference assistant device 132. Since a large number of user interface controls would necessitate drawing a user's attention away from a conference meeting, proving to be a distraction from the meeting itself, the conference assistant device 132 is designed to have limited user interface controls needed to keep interactions with the system intuitive. Depending on the current operational state of the conference assistant device 132, one or more user interface controls are configured to interact with the system. To keep interactions intuitive using a small number of user interface controls, each user interface control may perform different functions and/or be displayed with a different appearance between different states (e.g., may be made visible or invisible, can display a static color/pattern or a moving or pulsating color/pattern, can display text messages associated with the current operational state, etc.).

In the embodiments shown in FIGS. 3A-3F, for example, the conference assistant device 132 includes user interface control configurations using a capacitive touch button 216, an LCD display 214 (which can be, alternatively, an LED dot matrix text display), and one or more LED indicators 212. The LED indicators 212 can, in some embodiments, extend across each side of the conference assistant device 132, although the LED indicators 212 can be located in any position on the portable device 142 that's visible to the user.

FIG. 3A shows an example of the conference assistant device 132 in a boot operational state. In some embodiments, such as the boot state 410 in FIG. 4, the capacitive touch button 216 and LCD display 214 are invisible, but one or more LED indicators 212 may display at least one color in a moving or pulsating pattern. In some examples, touching the capacitive touch button 216 while it is invisible will have no effect. In addition, the LED indicators' 212 moving or pulsating pattern intuitively informs the user that the conference assistant device 132 is in the process of booting up.

Additionally and/or alternatively, the same user interface control features may also indicate that the conference assistant device 132 is in the process of connecting to the collaboration service 120 or portable device 142 (e.g., a connecting state). It will be appreciated that the specific appearance of a conference assistant device 132 may be modified or different than the one described. But whenever the conference assistant device 132 is in a boot operational state (410), the conference assistant device 132 should have an appearance that intuitively communicates to a user that the device is performing an operation but is not available for interaction.

In some embodiments, when the conference assistant device 132 is in a wake-up state (not shown), the device state control 202 is configured to cause speaker 244 to play a sound (e.g., a chime) to inform the user that the conference assistant device 132 is or has woken up. In addition, the LCD display 214 may cause text to appear associated with the device waking up.

FIG. 3B shows the conference assistant device 132 in a listening/volume control state. The capacitive touch button 216 is, in some embodiments, made invisible and is configured such that touching the capacitive touch button 216 will have no effect. The LED indicators 212 in this operational state may fade from one color to another color from top to bottom (e.g., from blue at the top to white at the bottom), with the bottom color representing the volume of sounds the microphone 242 picks up or the speaker 244 outputs. As the volume increases, the bottom color extends further up to the top of the LED indicators 212.

After the conference assistant device 132 has booted or is no longer in the process of connecting to the collaboration service 120, the conference assistant device 132 can enter a stand by state 420, in which the user interface controls on the conference assistant device 132 have a different configuration, functionality, and/or visual appearance from the same user interface controls in another state (e.g., such as the previous boot/connecting state 410). An example of a stand by state is shown in FIG. 3C. The LED indicators 212 in this operational state, in the shown embodiment, are visible, but have a static pattern or color. The capacitive touch button 216 is also visible, and can be made visible, for example, by identifying the capacitive touch button with an LCD circle drawn around the capacitive touch button 216. The LCD display 214 can display a text message associated with the stand by state 420. For example, the message may indicate that the conference assistant device 132 is on and is waiting for input to start a task. Accordingly, if the conference assistant device 132 needs user or conference participant input, the LCD display 214 can display a message of “Press Button” or “Press Button to Start.” Additionally, the capacitive touch button 216 can be configured to receive a touch input and, when such touch input is received, the conference assistant device 132 can provide an instruction queue via speaker 244 or LCD display 214 to instruct the user on how to pair with the conference assistant device 132, make a call, and/or join a conference.

The conference assistant device 132 can further enter into a user present—not paired state 430 (not shown in FIGS. 3A-3F), in which the conference assistant device 132 detects the presence of a user in the conference room 130 or vicinity of the conference room 130, but has not paired with the user's portable device 142. In that instance, an example interface configuration turns the LED indicators 212 off, but makes visible the LCD display 214 and the capacitive touch button 216. The LCD display 214 can display a message that indicates that a user or conference participant has been detected, but is not paired or identified, such as a generic “Welcome” message. The capacitive touch button 216 is made visible by drawing an LCD circle around the capacitive touch button 216 or other similar illumination around or on the capacitive touch button 216. The conference assistant device 132 can further provide audible instructions via speaker 244 or text instructions via the LCD display 214 that instructs the user on how to pair with the conference assistant device 132, make a call, and/or join a conference. These instructions can be triggered to start automatically upon detecting a user's presence, or may be initiated only after the capacitive touch button 216 has been activated.

The conference assistant device 132 can be in a paired state 440 (not shown in FIGS. 3A-3F) once the portable device 142 and the conference assistant device 120 are paired. Some embodiments contemplate that, while the LED indicators 212 are turned off and/or made invisible, the capacitive touch button 216 is made visible by drawing an LCD circle around the capacitive touch button 216 or illuminating it in any other way. Additionally and/or alternatively, the LCD display 214 can display a text message indicating that the conference assistant device 132 is in a paired state. For example the message may welcome the user by name (e.g., “Welcome Sideshow Bob”). In a redundant fashion, speaker 244 may play a welcome message such as welcoming the user by name and providing an initial instruction (e.g., “Welcome Sideshow Bob. Please touch the button to initiate the meeting.”). The capacitive touch button 216 is configured to receive a touch input and, when such touch input is received, the conference assistant device 132 can provide an instruction queue via speaker 244 or LCD display 214 to instruct the user on how to make a call or join a conference.

FIG. 3D shows the conference assistant device 132 in a join scheduled meeting state. In some embodiments, the LED indicators 212 are turned off and/or made invisible. The conference assistant device 132 intuitively informs the user that a meeting is scheduled and can be joined by making the capacitive touch button 216 visible and displaying meeting information in a message on the LCD display 214. For example, a green LCD circle drawn around the capacitive touch button and the LCD display 214 can display a text message indicating that a meeting is scheduled to start at a certain time.

In some embodiments, such as when conference assistant device 132 is in the join scheduled meeting operational state, the conference assistant device 132 can provide an audible query to the user using speaker 244. The audible query can acknowledge the scheduled meeting and ask the user if they would like to join. At the same time, LCD display 214 can display meeting information and capacitive touch button 216 can be visible and be configured to receive a touch input effective to cause conference assistant device 132 to join the user to the scheduled meeting.

In some embodiments, such as when conference assistant device 132 is in an in-call operational state shown in FIG. 3E, the LED indicators 212 can display a solid color (e.g., such as green), to indicate successful connection to the conference. At the same time, the capacitive touch button 216 can be visible and be configured to receive a touch input effective to cause the conference assistant device 132 to leave or end the scheduled meeting. In some embodiments, the in-call operational state 460 can cause the capacitive touch button 216 to be made visible within an “X” 310, an icon, or a color or pattern that intuitively instructs the user that activating the capacitive test button 216 will end the call. Additionally and/or alternatively, the LCD display 214 can be made invisible while the LED indicators 212 can display a visible, static pattern or color (e.g., a static green color indicating the meeting is in session). The in-call operational state can suppress the voice activated control. In alternative embodiments, the LCD display 214 can cause meeting information to be displayed as text while the voice activated control functionality is suppressed.

In some embodiments, such as that shown in FIG. 3F, the conference assistant device 132 can be in an in-call operational state (as directly above) but the line is muted. The LED indicators 212 can be, in the in call—microphone muted state 470, a different solid color (e.g., red instead of green) to indicate that the line is muted. The capacitive touch button 216 can be made visible within an “X” 310, an icon, or a color or pattern that intuitively instructs the user that activating the capacitive test button 216 will end the call, and the LCD display 214 can be made invisible.

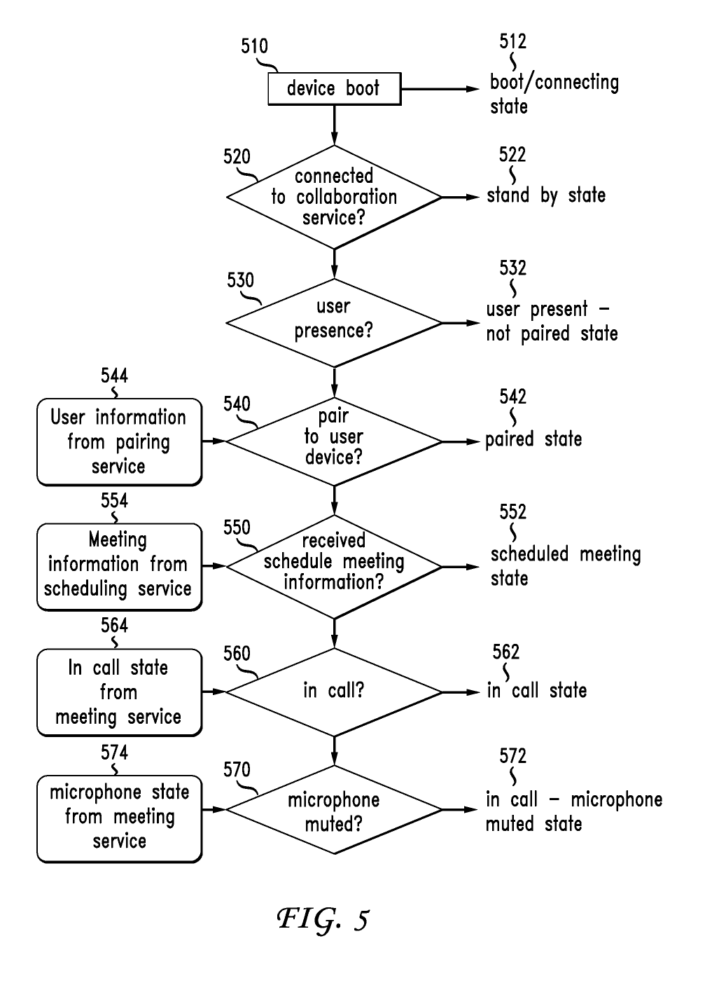

FIG. 5 is a flowchart illustrating an exemplary method 500 for determining an operational state of the conference assistant device 132 and, based on the determined operational state, adapting a configuration of one or more user interface controls. Although specific steps are shown in FIG. 5, in other embodiments a method can have more or less steps than shown. The method begins at the device boot (510), where, as the conference assistant device 132 turns on, it is determined that the conference assistant device 132 is in a boot/connecting state and configures itself accordingly (512).

After the device boot, the method 300 determines whether the conference assistant device 132 has connected to the collaboration service 120. If the conference assistant device 132 has connected, then the conference assistant device 132 configures itself into a stand by state (522).

At some point, the method 300 can determine whether a user or user device is present. If the method 300 determines that there is a user nearby (530), then the method 300 checks to see whether the conference assistant device 132 is paired to a user device (540). If the conference assistant device 132 is not paired, the conference assistant device 132 configures itself to be within a user present—not paired state (532). However, if the conference assistant device 132 is paired and has received user information from collaboration pairing service 310, then the conference assistant device 132 configures itself into a paired state (542).

The conference assistant device 132 can also receive meeting information from scheduling service 320 (554). When this happens, the conference assistant device 132 configures itself into a scheduled meeting state (552).

When the conference has started (560) and the collaboration service 120 transmits state information to the conference assistant device 132 that the conference is in session (e.g., in call state) (564), the conference assistant device 132 configures itself into the in call state (562) unless the microphone is muted. Once the microphone is muted (570) and the collaboration service 120 transmits microphone state information to the conference assistant device 132 that the microphone is muted, then the conference assistant device 132 configures itself into an in call—microphone muted state (572).

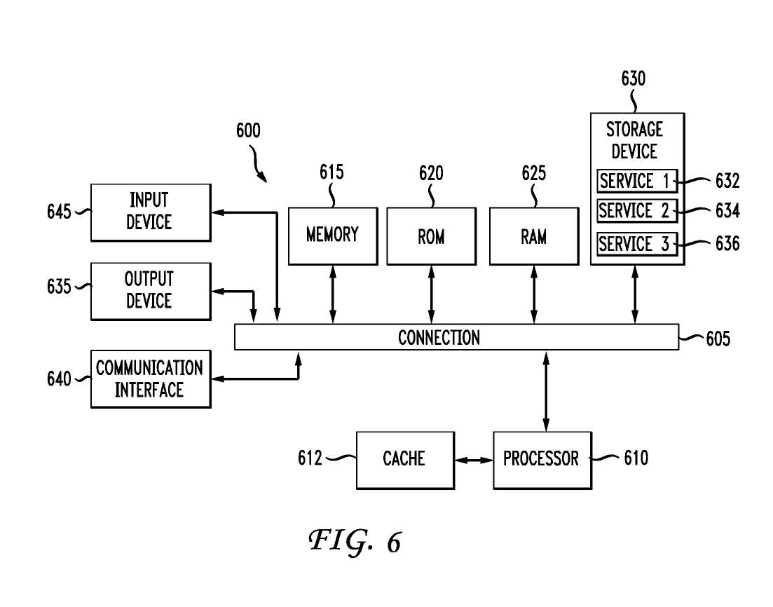

FIG. 6 shows an example of computing system 600 in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple datacenters, a peer network, etc. In some embodiments, one or more of the described system components represents many such components, each performing some or all of the function for which the component is described. In some embodiments, the components can be physical or virtual devices.

Example system 600 includes at least one processing unit (CPU or processor) 610 and connection 605 that couples various system components, including system memory 615, such as read only memory (ROM) and random access memory (RAM), to processor 610. Computing system 600 can include a cache of high-speed memory connected directly with, in close proximity to, or integrated as part of processor 610.

Processor 610 can include any general purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. There is no restriction on operating on any particular hardware arrangement and therefore the basic features here may easily be substituted for improved hardware or firmware arrangements as they are developed.

Storage device 630 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 630 can include software services, servers, services, etc., that when the code that defines such software is executed by the processor 610, it causes the system to perform a function. In some embodiments, a hardware service that performs a particular function can include the software component stored in a computer-readable medium in connection with the necessary hardware components, such as processor 610, connection 605, output device 635, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a portable device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A system comprising:
a conference assistant device at a first location, the conference assistant device including voice activated control and at least one other user interface control, wherein the conference assistant device is configured to adapt a configuration of each of the voice activated control and the at least one other user interface control based on an operational state of the conference assistant device; and
a collaboration service, the collaboration service configured to host a meeting between the first location and at least one remote location, the collaboration service, and the conference assistant device, the collaboration service configured to send conference state information to the conference assistant device.

2. The system of claim 1, wherein the conference assistant device is configured to determine the operational state from the conference state information received from the collaboration service.

3. The system of claim 1, wherein the at least one other user interface control is a touch activated control.

4. The system of claim 1, wherein the conference assistant device includes at least one device state indicator that is configured to adapt a visual appearance based on the operational state of the conference assistant device.

5. The system of claim 4, wherein the at least one device state indicator includes a LED indicator, or a display.

6. The system of claim 4, wherein the wherein the at least one device state indicator is multiple indicators and includes a speaker, a LED indicator, a text display, and a symbol display.

7. The system of claim 3, wherein the voice activated control and the at least one other user interface control are configured to receive inputs and provide commands based on the operational state of the conference assistant device to the collaboration service.

8. The system of claim 7, comprising:
a personal computing device application configured to transmit account credentials to the collaboration service, to pair with the conference assistant device, and configured to provide commands to the collaboration service, wherein the commands that can be provided by the personal computing device application, and the commands that can be provided by the conference assistant device are redundant.

9. A conference assistant device comprising:
a voice activated control;
at least one other user interface control, and
a device state control configured to adapt a configuration of each the voice activated control and the at least one other user interface control based on an operational state of the conference assistant device.

10. The conference assistant device of claim 9, wherein the at least one other user interface control is a touch activated control.

11. The conference assistant device of claim 10, comprising:
at least one device state indicator that is configured to adapt a visual appearance based on the operational state of the conference assistant device.

12. The conference assistant device of claim 11, wherein the at least one device state indicator is multiple indicators and includes a speaker, a LED indicator, a text display, and a symbol display.

13. The conference assistant device of claim 12, wherein the operational state of the conference assistant device is a wake-up state, the device state control is configured to cause the speaker to play a chime, and cause the text display to appear.

14. The conference assistant device of claim 12, wherein the operational state of the conference assistant device is a scheduled meeting state, the device state control is configured to cause the speaker to playback instructions, cause the text display to appear and display meeting information, activate the touch activated control, cause the symbol display to appear around the touch activated control, and activate the voice activated control.

15. The conference assistant device of claim 12, wherein the operational state of the conference assistant device is an in-meeting state, the device state control is configured to cause the text display to appear and display meeting information, activate the touch activated control, and cause the symbol display on the touch activated control, and to suppress the voice activated control.

16. The conference assistant device of claim 12, wherein the text display, the symbol display, and the touch activated control are not visible when not activated.
